(19) United States
(12) Patent Application Publication
(10) Pub. No.: US 2005/0047664 A1
(43) Pub. Date: Mar. 3, 2005

(54) Identifying a speaker using markov models

(76) Inventors: Ara Victor Nefian, Santa Clara, CA (US); Lu Hong Liang, Beijing (CN)

Correspondence Address: TROP PRUNER & HU, PC, 8554 KATY FREEWAY, SUITE 100, HOUSTON, TX, 77024, US

(21) Appl. No.: 10/649,070

(22) Filed: Aug. 27, 2003

(51) Int. Cl. G06K 9/62

(52) U.S. Cl. 382/228

(57) ABSTRACT

In one embodiment, the present invention includes a method of modeling an audio-visual observation of a subject using a coupled Markov model to obtain an audio-visual model; modeling the subject's face using an embedded Markov model to obtain a face model; and determining first and second likelihoods of identification based on the audio-visual model and the face model. The two likelihoods may then be combined to identify the subject.

### BACKGROUND

The present invention relates to subject identification and more specifically to audio-visual speaker identification.

Audio-visual speaker identification (AVSI) systems provide for identification of a speaker or subject using audio-visual (AV) information obtained from the subject. Such information may include speech of the subject as well as a visual representation of the subject.

For various systems that combine acoustic speech features with facial or visual speech features to determine a subject's identity, different problems exist. Such problems include complexity of modeling the audio-visual and speech features. Also, the systems are typically not robust, especially in the presence of noise, particularly acoustic noise. Accordingly, a need exists for an audio-visual speaker identification system to provide accurate speaker identification under varying environmental conditions, including noise.

### BRIEF DESCRIPTION OF THE DRAWINGS

FIG. 1 is a block diagram of an audio-visual speaker identification system in accordance with one embodiment of the present invention.

FIG. 2 is a block diagram of an embedded hidden Markov model in accordance with one embodiment of the present invention.

FIG. 3 is an illustration of facial feature block extraction in accordance with one embodiment of the present invention.

FIG. 4 is a directed graphical representation of a two-channel coupled hidden Markov model in accordance with one embodiment of the present invention.

FIG. 5 is a state diagram of the coupled hidden Markov model of FIG. 4.

FIG. 6 is a flow diagram of a training method in accordance with one embodiment of the present invention.

FIG. 7 is a flow diagram of a recognition method in accordance with one embodiment of the present invention.

FIG. 8 is a block diagram of a system in accordance with one embodiment of the present invention.

### DETAILED DESCRIPTION

In various embodiments, a text dependent audio-visual speaker identification approach may combine face recognition and audio-visual speech-based identification systems. A temporal sequence of audio and visual observations obtained from acoustic speech and mouth shape may be modeled using a set of coupled hidden Markov models (CHMM), one for each phoneme-viseme pair and for each person in a database. The database may include entries for a number of individuals desired to be identified by a system. For example, a database may include entries for employees of a business having a security system in accordance with an embodiment of the present invention.

In certain embodiments, the CHMMs may describe the natural audio and visual state asynchrony, as well as their conditional dependence over time.

Next, an AV likelihood obtained for each person in the database may be combined with a face recognition likelihood obtained using an embedded hidden Markov model (EHMM). In such manner, in certain embodiments accuracy over audio-only or video-only speaker identification at levels of acoustic signal-to-noise ratio (SNR) from approximately 5 to 30 decibels (db) may be improved.

In one embodiment, a Bayesian approach to audio-visual speaker identification may begin with detection of a subject's face and mouth in a video sequence. The facial features may be used in the computation of face likelihood, while the visual features of the mouth region together with acoustic features of the subject may be used to determine likelihood of audio-visual speech. Then, the face and audio-visual speech likelihood may be combined in a late integration scheme to reveal the identity of the subject.

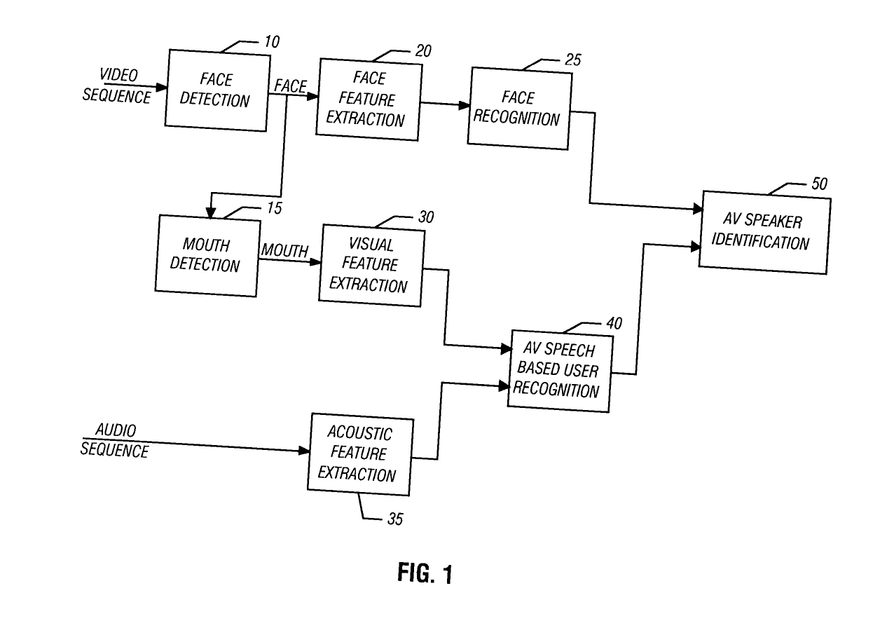

Referring now to FIG. 1, shown is a block diagram of an AV speaker identification system in accordance with one embodiment of the present invention. While shown in FIG. 1 as a plurality of units, it is to be understood that in certain embodiments, the units may be combined into a single functional or hardware block, or a smaller or larger number of such units, as desired by a particular embodiment.

As shown in FIG. 1, a video sequence may be provided to a face detection unit 10. Face detection unit 10 may detect a face within the video sequence. The detected face may be provided to a face feature extraction unit 20 and a mouth detection unit 15. Face feature extraction unit 20 may extract a desired facial feature and provide it to face recognition unit 25, which may perform visual recognition by comparing the extracted facial feature to various entries in a database (e.g., a trained model for each person to be identified by the system). While discussed as extraction of a face feature, in other embodiments extraction of another visual feature of a subject such as a thumbprint, a handprint, or the like, may be performed. In one embodiment, a recognition score for each person in the database may be determined in face recognition unit 25.

Still referring to FIG. 1, the detected face may also be provided to a mouth detection unit 15 to detect a mouth portion of the face. The mouth portion may be provided to a visual feature extraction unit 30 to extract a desired visual feature from the mouth region and provide it to an AV speech-based user recognition unit 40.

Also, an audio sequence obtained from the subject may be provided to an acoustic feature extraction unit 35, which may extract a desired acoustic feature from the subject's speech and provide it to AV speech based user recognition unit 40. In recognition unit 40, the combined audio-visual speech may be compared to entries in a database (e.g., a trained model for each person) and a recognition score for the AV speech may be obtained.

Finally, both the face recognition score and the AV speech recognition score may be provided to an audio-visual speaker identification unit 50 for a determination (i.e., identification) of the subject. In various embodiments, the likelihood of AV speech may be combined with the likelihood of facial feature and, in certain embodiments the different likelihoods may be weighted. For example, in one embodiment the facial likelihood and the AV speech likelihood may be weighted in accordance with predetermined weighting coefficients.

In certain embodiments, face images may be modeled using an embedded HMM (EHMM). The EHMM used for face recognition may be a hierarchical statistical model with two layers of discrete hidden nodes (one layer for each data dimension) and a layer of observation nodes. In such an EHMM, both “parent” and “child” layers of the hidden nodes may be described by a set of HMMs.

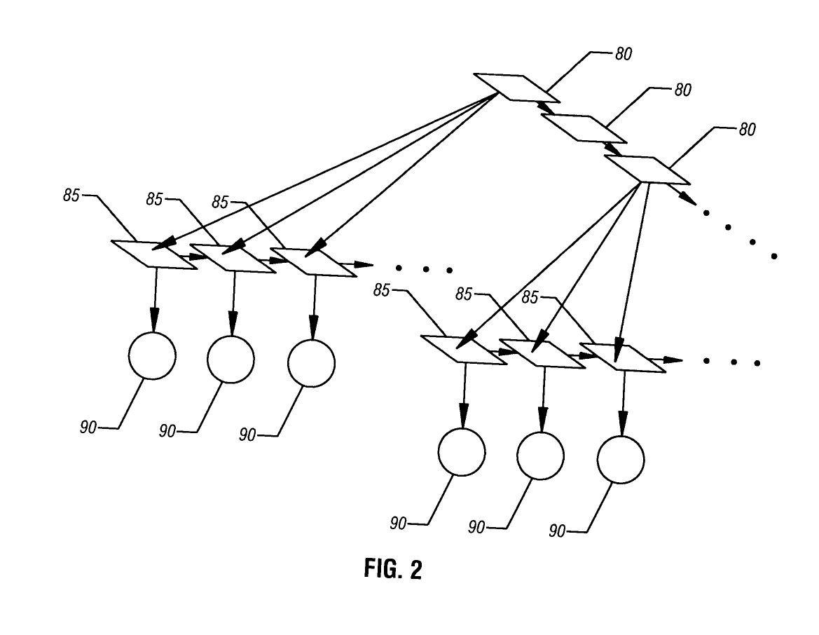

Referring now to FIG. 2, shown is a graphical representation of a two-dimensional EHMM in accordance with one embodiment of the present invention. As shown in FIG. 2, the EHMM includes a parent layer having a plurality of square nodes 80 representing discrete hidden nodes. As shown in FIG. 2, nodes 80 of the parent layer each may refer to a child layer, which includes discrete hidden nodes 85 and continuous observation nodes 90.

The states of the HMM in the “parent” and “child” layers may be referred to as the super states and the states of the model, respectively. The hierarchical structure of the EHMM or an embedded Bayesian network in general may reduce significantly the complexity of these models.

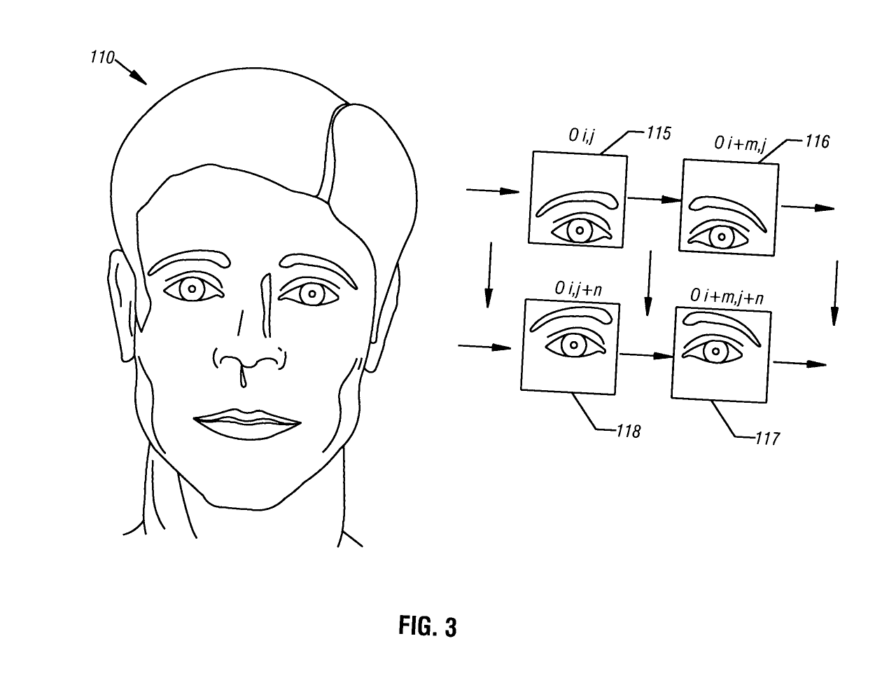

In one embodiment, a sequence of observation vectors for an EHMM may be obtained from a window that scans an image from left to right and top to bottom. Referring now to FIG. 3, shown is an image 110 which includes a subject's face. Facial features may be extracted from image 110 as a plurality of observation vectors (O). Specifically, as shown in FIG. 3, a sampling window may include positions 115, 116, 117 and 118 which are obtained in order from left to right and top to bottom. As shown, observation vectors O_{i,j}, O_{i+m,j}, O_{i+m,j+n}, and O_{i,j+n} may be obtained from image 110.

In this embodiment, the facial features may be obtained using a sampling window of size 8×8 having a 75% overlap between consecutive windows. The observation vectors corresponding to each position of the sampling window may be a set of two dimensional (2D) discrete cosine transform (2D DCT) coefficients. As an example, nine 2D DCT coefficients may be obtained from a 3×3 region around the lowest frequency in the 2D DCT domain.

The faces of all people in a database may be modeled using an EHMM with five super states and 3,6,6,6,3 states per super state, respectively. Each state of the hidden nodes in the “child” layer of the EHMM may be described by a mixture of three Gaussian density functions with diagonal covariance matrices, in one embodiment.

In one embodiment, audio-visual speech may be processed using a CHMM with two channels, one for audio and the other for visual observations. Such a CHMM may be seen as a collection of HMMs, one for each data stream, where hidden backbone nodes at time t for each HMM are conditioned by backbone nodes at time t−1 for all related HMMs.

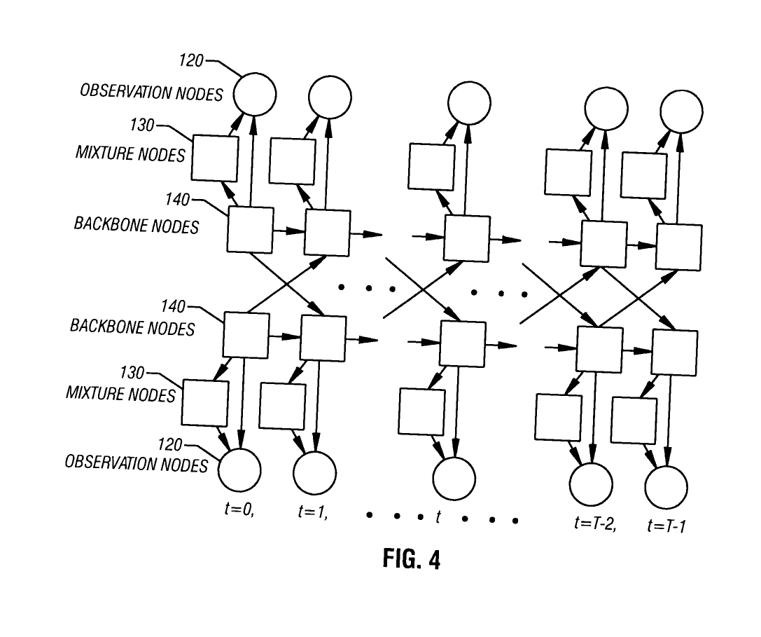

Referring now to FIG. 4, shown is a directed graphical representation of a two-channel CHMM with mixture components in accordance with one embodiment of the present invention. As shown in FIG. 4, such a CHMM may include observation nodes 120 and backbone nodes 140. Backbone nodes 140 may be coupled to observation nodes 120 via mixture nodes 130. More so, backbone nodes 140 of time t=0, for example, may be coupled to backbone nodes 140 of time t=1, so that the backbone nodes 140 of time t=1 are conditioned by backbone nodes 140 of time t=0.

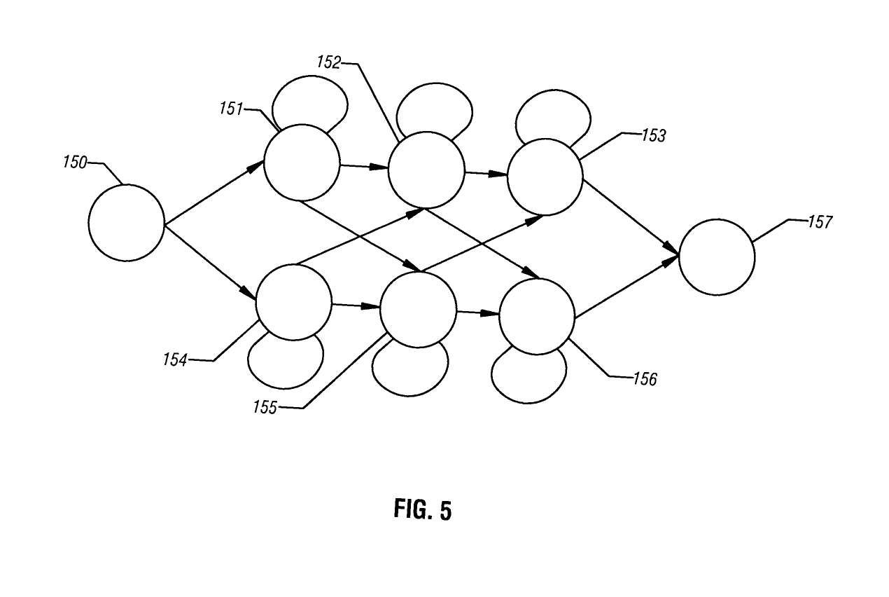

FIG. 5 shows a state diagram of the CHMM of FIG. 4. As shown in FIG. 5, the CHMM may have an initial state 150. Information regarding audio and visual observations may be provided to, respectively, states 151, 152 and 153 of a first channel and states 154, 155, and 156 of a second channel. The results of the CHMM may be provided to state 157. In such an embodiment, each CHMM may describe one of the possible phoneme-viseme pairs for each person in the database.

The parameters of a CHMM with two channels in accordance with one embodiment of the present invention may be defined as follows:
π₀^{c}(i)=P(q₁^{c}=i) [1]
bₜ^{c}(i)=P(Oₜ^{c}|qₜ^{c}=i) [2]
a_{i|j,k}^{c}=P(qₜ^{c}=i|qₜ₋₁^{a}=j,qₜ₋₁^{v}=k) [3]
where π is the initial state distribution, b is an observation probability matrix, a is a state transition probability matrix, c ε {a, v} denotes the audio and visual channels respectively, and qₜ^{c} is the state of the backbone node in the c^{th} channel at time t. For a continuous mixture with Gaussian components, the probabilities of the observed nodes are given by:

$${b}_{t}^{c} ( i ) = {\sum }_{m = 1}^{{M}_{i}^{c}} {w}_{i , m}^{c} N ( {O}_{t}^{c} , {μ}_{i , m}^{c} , {U}_{i , m}^{c} ) \qquad [ 4 ]$$

where Oₜ^{c} is the observation vector at time t corresponding to channel c, and μ_{i,m}^{c} and U_{i,m}^{c} and w_{i,m}^{c} are the mean, covariance matrix and mixture weight corresponding to the i^{th} state, the m^{th} mixture, and the c^{th} channel. Mᵢ ^{c} is the number of mixtures corresponding to the i^{th} state in the c^{th} channel, and N is the normal density (Gaussian) function.

In one embodiment, acoustic observation vectors may include a number of Mel frequency cepstral (MFC) coefficients with their first and second order time derivatives. For example, in one embodiment, 13 MFC coefficients may be obtained, each extracted from windows of 25.6 milliseconds (ms), with an overlap of 15.6 ms.

In one embodiment, extraction of visual speech features may begin with face detection in accordance with a desired face detection scheme, followed by the detection and tracking of the mouth region using a set of support vector machine classifiers. In one embodiment, the features of visual speech may be obtained from the mouth region through, for example, a cascade algorithm. The pixels in the mouth region may be mapped to a 32-dimensional feature space using a principal component analysis. Then blocks of, for example, 15 consecutive visual observation vectors may be concatenated and projected on a 13 class, linear discriminant space. Finally, resulting vectors, with their first and second order time derivatives, may be used as visual observation sequences.

The audio and visual features of speech may be integrated using a CHMM with three states in both the audio and video chains with no back transitions, as shown, for example, in FIG. 5. In one embodiment, each state may have 32 mixture components with diagonal covariance matrices.

Prior to use of a system for identification, a training phase may be performed for all individuals to be recognized by the system. Using the audio visual sequences in a training set, an EHMM and a set of CHMMs may be trained for the face and the set of phoneme-viseme pairs corresponding to each person in the database by means of an expectation-maximization (EM) algorithm, for example.

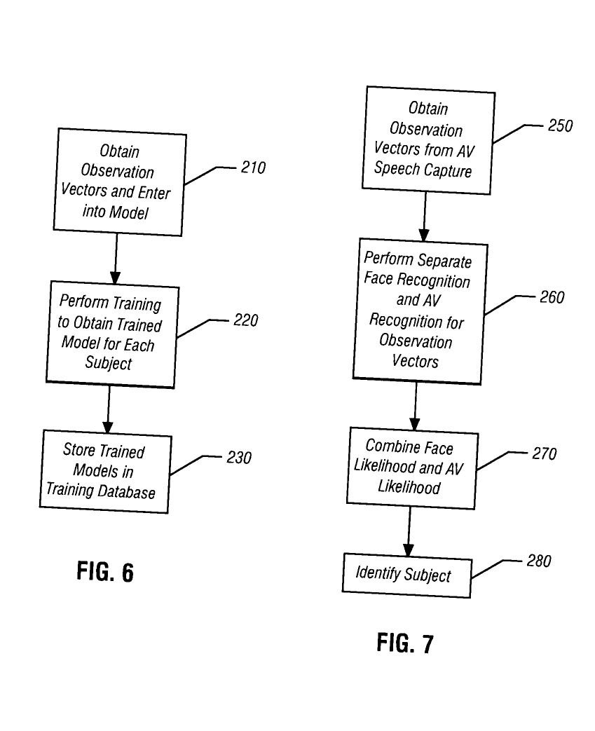

Referring now to FIG. 6, shown is a flow diagram of a training method in accordance with one embodiment of the present invention. As shown in FIG. 6, observation vectors may be obtained and entered into a model (block 210). For example, facial features and audio-visual features of speech may be obtained from audio and visual sequences and observation vectors obtained therefrom. The observation vectors may be, for example, DCT coefficients or MFC coefficients, which may be entered into the appropriate model. In one embodiment, the facial features may be modeled using an EHMM and the AV features of speech modeled using a CHMM. Then, training may be performed to obtain a trained model for each subject (block 220). That is, based on the observation vectors, the model may be initialized and initial estimates obtained for an observation probability matrix.

Next, the model parameters may be re-estimated, for example, using an EM procedure to maximize the probability of the observation vectors. When a model convergence has been achieved, the trained models may be stored in a training database (block 230).

In one embodiment, training of CHMM parameters may be performed in two stages. First a speaker-independent background model (BM) may be obtained for each CHMM corresponding to a viseme-phoneme pair. Next, the parameters of the CHMMs may be adapted to a speaker specific model using a maximum a posteriori (MAP) method. In certain embodiments for use in continuous speech recognition systems, two additional CHMMs may be trained to model the silence between consecutive words and sentences.

In one embodiment of such training, the face of each individual in the database may be represented by an EHMM face model. A set of five images representing different instances of the same face may be used to train each HMM.

Following the block extraction, a set of, for example, 9 2D-DCT coefficients obtained from each block may be used to form the observation vectors. The observation vectors may then be effectively used in the training of each HMM.

First the EHMM λ=(a, b, π) may be initialized. The training data may be uniformly segmented from top and bottom in a desired number of states and the observation vectors associated with each state may be used to obtain initial estimates of the observation probability matrix b. The initial values for a and π may be set, given a left to right structure of the face model.

Next, the model parameters may be re-estimated using an EM procedure to maximize P(O|λ). The iterations may stop after model convergence is achieved, i.e., when the difference between model probability at consecutive iterations (k and k+1) is smaller than a threshold C:
P(O|λ^{k+1)})−P(O|λ^{(k)})|<C [5]

After such training, recognition may be performed using various algorithms. For example, in one embodiment, a Viterbi decoding algorithm may be used to perform the recognition.

Referring now to FIG. 7, shown is a flow diagram of a recognition method in accordance with one embodiment of the present invention. As shown in FIG. 7, observation vectors may be obtained from audio-visual speech capture (block 250). For example, observation vectors may be obtained as discussed above for the training sequence. Then, separate face recognition and audio visual recognition may be performed for the observation vectors (block 260). In such manner, a likelihood of face and a likelihood of audio-visual speech may be determined. In one embodiment, these likelihoods may be expressed as recognition scores. Based on the recognition scores, face likelihood and AV likelihood may be combined (block 270). While in one embodiment the face and AV speech likelihood may be given equal weightings, in other embodiments different weightings between face likelihood and AV likelihood may be desired. Such weightings may be desirable, for example, when it is known that noise, such as acoustic noise is present in the capture environment. Finally, the subject may be identified based on the combined likelihoods (block 280).

In certain embodiments, to deal with variations in the relative reliability of audio and visual features of speech at different levels of acoustic noise, observation probabilities used in decoding may be modified such that:
P(Oₜ^{c}|qₜ^{c=i})=[P(Oₜ^{c}|qₜ^{c}=i)]^{λ}^{_{c}} [6]
where Oₜ^{c} ε {a, v} are the audio and video observations at time t, qₜ^{c} is the state of the backbone node at time t in channel c, such that λ_{c} represents an audio or video stream exponent λₐ or λᵥ, and the audio and video stream exponents satisfy λₐ, λᵥ≧0 and λₐ+λᵥ=1. Then an overall matching score of the audio-visual speech and face model may be computed as:
L(O^{f},O^{a}, O^{v}|k)=λ_{f}L(O^{f}|k)+λₐᵥL(O^{a}, O^{v}|k) [7]
where O^{a}, O^{v} and O^{f} are the acoustic speech, visual speech and facial sequence of observations, L(*|k) denotes the observation likelihood for the k^{th} person in the database and λ_{f}, λₐᵥ≧0, λ_{f}+λₐᵥ=1 are weighting coefficients for the face and audio-visual speech likelihoods.

A system in accordance with the present invention may provide a robust framework for various systems involving human-computer interaction and security such as access control in restricted areas such as banks, stores, corporations, and the like; credit card access via a computer network, such as the Internet; home security devices; games, and the like.

Thus in various embodiments, a text-dependent audio-visual speaker identification system may use a two-stream coupled HMM and an embedded HMM to model the audio-visual speech and the speaker's face, respectively. The use of such a unified Bayesian approach to audio-visual speaker identification may provide for fast and computationally efficient implementation on a parallel architecture.

Example embodiments may be implemented in software for execution by a suitable data processing system configured with a suitable combination of hardware devices. As such, these embodiments may be stored on a storage medium having stored thereon instructions which can be used to program a computer system or the like to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) (e.g., dynamic RAMs, static RAMs, and the like), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

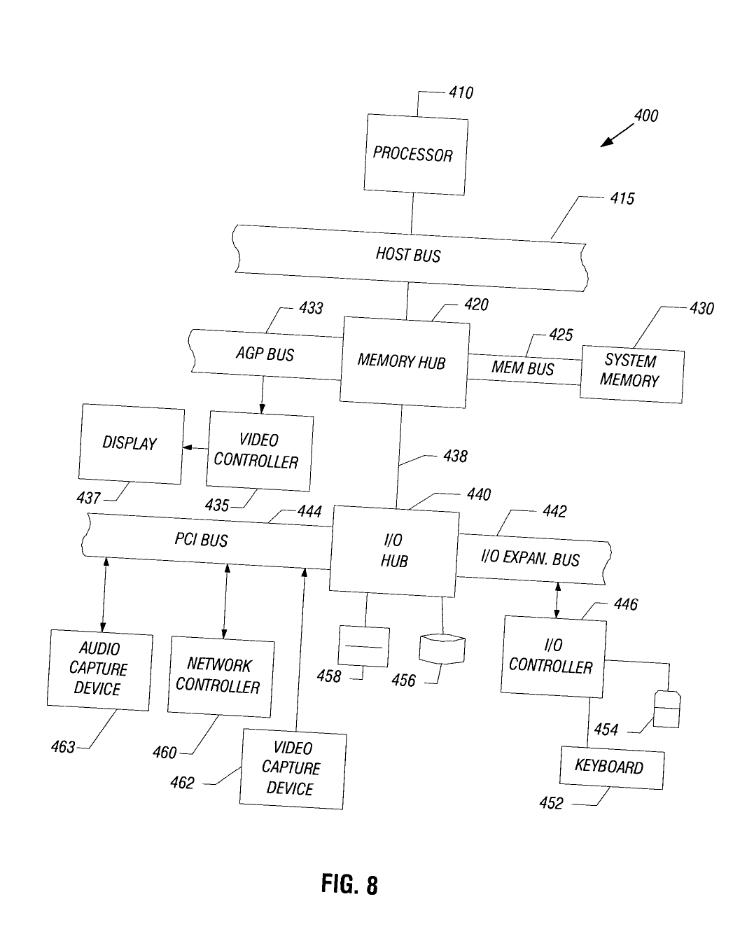

FIG. 8 is a block diagram of a representative data processing system, namely computer system 400 with which embodiments of the invention may be used.

Now referring to FIG. 8, in one embodiment, computer system 400 includes processor 410, which may be a general-purpose or special-purpose processor such as a microprocessor, microcontroller, ASIC, a programmable gate array (PGA), and the like. As used herein, the term “computer system” may refer to any type of processor-based system, such as a desktop computer, a server computer, a laptop computer, an appliance or set-top box, or the like.

Processor 410 may be coupled over host bus 415 to memory hub 420 in one embodiment, which may be coupled to system memory 430 via memory bus 425. In certain embodiments, system memory 430 may store a database having trained models for individuals to be identified using the system. Memory hub 420 may also be coupled over Advanced Graphics Port (AGP) bus 433 to video controller 435, which may be coupled to display 437. AGP bus 433 may conform to the Accelerated Graphics Port Interface Specification, Revision 2.0, published May 4, 1998, by Intel Corporation, Santa Clara, Calif.

Memory hub 420 may also be coupled (via hub link 438) to input/output (I/O) hub 440 that is coupled to input/output (I/O) expansion bus 442 and Peripheral Component Interconnect (PCI) bus 444, as defined by the PCI Local Bus Specification, Production Version, Revision 2.1, dated in June 1995. I/O expansion bus 442 may be coupled to I/O controller 446 that controls access to one or more I/O devices. As shown in FIG. 8, these devices may include in one embodiment I/O devices, such as keyboard 452 and mouse 454. I/O hub 440 may also be coupled to, for example, hard disk drive 456 and compact disc (CD) drive 458, as shown in FIG. 8. It is to be understood that other storage media may also be included in the system. In an alternative embodiment, I/O controller 446 may be integrated into I/O hub 440, as may other control functions.

PCI bus 444 may also be coupled to various components including, for example, video capture device 462 and audio capture device 463, in an embodiment in which such video and audio devices are coupled to system 400. Of course, such devices may be combined as a single device, such as a video camera or the like. However, in other embodiments, it is to be understood that a video camera, microphone or other audio-visual capture devices may be remotely provided, such as at a security camera location, and data therefrom may be provided to system 400, via a wired or wireless connection. Alternately, the audio-visual information may be provided to system 400 via a network, for example via network controller 460.

Additional devices may be coupled to I/O expansion bus 442 and PCI bus 444, such as an input/output control circuit coupled to a parallel port, serial port, a non-volatile memory, and the like.

Although the description makes reference to specific components of system 400, it is contemplated that numerous modifications and variations of the described and illustrated embodiments may be possible. For example, instead of memory and I/O hubs, a host bridge controller and system bridge controller may provide equivalent functions. In addition, any of a number of bus protocols may be implemented.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
modeling an audio-visual observation of a subject using a coupled Markov model to obtain an audio-visual model;
modeling a portion of the subject using an embedded Markov model to obtain a portion model; and
determining first and second likelihoods of identification based on the audio-visual model and the portion model.

2. The method of claim 1, wherein modeling the audio-visual observation comprises using a coupled hidden Markov model.

3. The method of claim 2, wherein the coupled hidden Markov model comprises a two-channel model, each channel having observation nodes coupled to backbone nodes via mixture nodes.

4. The method of claim 1, further comprising combining the first and second likelihoods of identification.

5. The method of claim 4, further comprising weighting the first and second likelihoods of identification.

6. The method of claim 1, wherein the portion of the subject comprises a mouth portion.

7. A method comprising:
recognizing a face of a subject from first entries in a database;
recognizing audio-visual speech of the subject from second entries in the database; and
identifying the subject based on recognizing the face and recognizing the audio-visual speech.

8. The method of claim 7, further comprising providing the subject access to a restricted area after identifying the subject.

9. The method of claim 7, wherein recognizing the face comprises modeling an image including the face using an embedded hidden Markov model.

10. The method of claim 9, further comprising obtaining observation vectors from a sampling window of the image.

11. The method of claim 10, wherein the observation vectors comprise discrete cosine transform coefficients.

12. The method of claim 7, wherein recognizing the face comprises performing a Viterbi decoding algorithm.

13. The method of claim 7, wherein recognizing the audio-visual speech further comprises detecting and tracking a mouth region using vector machine classifiers.

14. The method of claim 7, wherein recognizing the audio-visual speech comprises modeling an image and an audio sample using a coupled hidden Markov model.

15. The method of claim 7, further comprising combining results of recognizing the face and recognizing the audio-visual speech pattern according to a predetermined weighting to identify the subject.

16. A system comprising:
at least one capture device to capture audio-visual information from a subject;
a first storage device coupled to the at least one capture device to store code to enable the system to recognize a face of the subject from first entries in a database, recognize audio-visual speech of the subject from second entries in the database, and identify the subject based on the face and the audio-visual speech; and
a processor coupled to the first storage to execute the code.

17. The system of claim 16, wherein the database is stored in the first storage device.

18. The system of claim 17, further comprising code that if executed enables the system to model an image including the face using an embedded hidden Markov model.

19. The system of claim 16, further comprising code that if executed enables the system to model an image and an audio sample using a coupled hidden Markov model.

20. An article comprising a machine-readable storage medium containing instructions that if executed enable a system to:
recognize a face of a subject from first entries in a database;
recognize audio-visual speech of the subject from second entries in the database; and
identify the subject based on recognizing the face and recognizing the audio-visual speech.

21. The article of claim 20, further comprising instructions that if executed enable the system to provide the subject access to a restricted area after the subject is identified.

22. The article of claim 20, further comprising instructions that if executed enable the system to model an image including the face using an embedded hidden Markov model.

23. The article of claim 20, further comprising instructions that if executed enable the system to model an image and an audio sample using a coupled hidden Markov model.
